(19) United States
(12) Patent Application Publication
(10) Pub. No.: US 2021/0143496 A1
(43) Pub. Date: May 13, 2021

(54) COOLING ELEMENT OF AN ELECTRICAL STORAGE DEVICE FOR A MOTOR VEHICLE

(71) Applicant: Valeo Systemes Thermiques, Le Mesnil-Saint-Denis (FR)

(72) Inventors: Eric Tudeau, La Suze Sur Sarthe (FR); Frédéric Tison, La Suze Sur Sarthe (FR); Jean Damien Muller, La Suze Sur Sarthe (FR); Dinh-Luyen Nguyen, Le Mesnil Saint Denis (FR); Daniel Pereira, Le Mesnil Saint-Denis (FR); Patrick Dormoy, Le Mesnil Saint Denis (FR); Nathalie Girard, Le Mesnil Saint-Denis (FR); Fernando Fernandes Pereira Da Venda, Le Mesnil Saint Denis (FR); Benoît Martin, La Suze Sur Sarthe (FR)

(73) Assignee: Valeo Systemes Thermiques, Le Mesnil-Saint-Denis (FR)

(21) Appl. No.: 16/956,373

(22) PCT Filed: Dec. 20, 2018
(86) PCT No.: PCT/FR2018/053492

§ 371 Date: Jan. 13, 2021

(30) Foreign Application Priority Data
Dec. 20, 2017 (FR) 1762576

(51) Int. Cl. H01M 10/6556; H01M 10/613; H01M 10/625

(52) U.S. Cl. CPC H01M 10/6556; H01M 2220/20; H01M 10/625; H01M 10/613

(57) ABSTRACT

The present invention concerns a cooling element (100) of an electrical storage device (200) for a motor vehicle, comprising at least one first wall (110) extending primarily in a first plane and in which is created at least one first channel (113) and at least one second wall (120) extending primarily in a second plane and which is created at least one second channel (123), the first channel (113) and the second channel (123) being adapted to be taken by a heat transport fluid.

According to the invention the first plane in which the first wall (110) extends and the second plane in which the second wall (120) extends intersect and at least the first wall (110) is configured to support the electrical storage device (200).

### 1. TECHNICAL FIELD OF THE INVENTION

The technical field of the present invention concerns the thermal regulation of an electrical storage device and the present invention relates more particularly to the thermal regulation of an electrical storage device intended for electric or hybrid motor vehicles.

### 2. PRIOR ART

Electrical energy is supplied to electric and/or hybrid vehicles by one or more batteries.

In this type of vehicle electrical energy is supplied by a plurality of electrical cells assembled so as to form an electrical module.

An electrical storage device formed of a plurality of electrical modules can then be disposed in a protective casing so that the assembly forms what is called a battery pack.

A problem that arises lies in the fact that during its operation the electrical storage device is caused to heat up and there is therefore a risk of it being damaged.

Moreover, in the case of too low a temperature, the autonomy of the electrical storage device may decrease greatly.

Consequently, thermal regulation of this electrical storage device is important in order to maintain the latter at an acceptable temperature.

In fact, the temperature of the electrical storage device must remain between 20° C. and 40° C. inclusive in order to ensure the reliability, autonomy and performance of the vehicle whilst optimizing the service life of that electrical storage device.

This regulation of the temperature of the electrical storage device, in particular cooling thereof, is in particular provided by means of a heat transport fluid that circulates in thermal regulation devices placed inside the protective casing of the battery pack.

These thermal regulation devices take the form of tube or plate type heat exchangers.

As a general rule the thermal regulation devices are disposed at the bottom of the protective casing of the battery pack, under the electrical modules.

However, the mechanical strength of such thermal regulation devices is relatively low, which can cause a problem in the event of impacts (occurring if the vehicle is involved in an accident, for example).

Moreover, if the thermal regulation devices are disposed inside the battery pack, there exists a risk of destruction of the modules in the event of leaks of heat transport fluid into the interior enclosure of the battery pack.

Another disadvantage of this approach resides in the fact that the space allocated to receive battery modules in the battery pack is reduced because of the presence of the thermal regulation devices, which are relatively bulky.

The power and the electrical autonomy of the vehicle are therefore not maximized.

### 3. SUMMARY OF THE INVENTION

An object of the invention is to alleviate at least some of the disadvantages of the prior art cited hereinabove.

To this end the invention consists in a cooling element of an electrical storage device for a motor vehicle, comprising at least one first wall extending primarily in a first plane and in which is created at least one first channel and at least one second wall extending primarily in a second plane and which is created at least one second channel, the first channel and the second channel being adapted to be taken by a heat transport fluid. According to the invention the first plane in which the first wall extends and the second plane in which the second wall extends intersect and at least the first wall is configured to support the electrical storage device.

By “first wall configured to support the electrical storage device” is meant that this first wall is sufficiently rigid to serve as a support for the electrical storage device. The heat transport fluid that circulates in the first channel and in the second channel may advantageously be a cooling fluid.

According to one feature of the present invention the electrical storage device is arranged in contact with the first wall and with the second wall.

Thus the cooling element according to the present invention has both a structural function of supporting the electrical storage device and a thermal regulation function, in particular a cooling function, for the electrical storage device, thanks to channels created, at least in part, directly in the first wall that participates in the structural function of said cooling element. The first and second walls of the cooling element are therefore support and thermal regulation walls.

The channels created in the walls of the cooling element are sized so as to ensure the integrity of the electrical storage device despite routine and accidental mechanical stresses occurring during the service life of the vehicle and the transport of a heat transport fluid whilst preserving the seal of the heat transport fluid circulation circuit.

Two functions being provided by a single component, the approach of the invention enables the overall size of a thermal treatment system comprising the cooling element according to the invention and the electrical storage device to be minimized.

For example, the first plane in which the first wall primarily extends and the second plane in which the second wall primarily extends may be perpendicular.

The electrical storage devices generally being of parallelepiped shape, an arrangement of this kind of the first and second walls enables optimization of the arrangement of the latter on the cooling assembly and minimization of the overall size of the thermal treatment system integrating a cooling assembly of this kind. Moreover, the electrical storage devices being in contact with the first and with the second wall of the cooling element in this example, their thermal regulation is optimized.

According to the invention, the cooling element comprises fluidic connection means configured to connect the first channel created in the first wall to the second channel created in the second wall, each fluidic connection means being created within said first and second walls.

The fact that the fluidic connections between the channels are created within the thickness of the walls of the cooling element enables external connections to be dispensed with, the risks of the heat transport fluid leaking minimized and the overall size of the cooling element reduced.

According to the invention the cooling element may also comprise at least one first duct intended to supply the first and/or the second channel with heat transport fluid and at least one second duct intended to evacuate the heat transport fluid circulating in the first and/or the second channel, the first duct and the second duct being created in the second wall of the cooling element.

Again, the fact that the ducts for supplying heat transport fluid to the channels and evacuating the fluid coming from the channels are created within the thickness of the walls of the cooling element enables the overall size of that cooling element to be reduced by dispensing with external connections (pipes, for example).

The elimination of external connections of this kind also enables the risks of leaks of heat transport fluid to be minimized.

According to another particular aspect of the invention the cooling element comprises a plurality of ducts for supplying and evacuating heat transport fluid.

A configuration of this kind enables minimization of the head losses of the heat transport fluid in the circulation circuit for the fluid created within the walls of the cooling element.

According to one feature of the present invention the cooling element comprises at least one fluidic connection flange configured to connect the cooling element to an external circuit via the first and/or the second duct(s).

A connecting flange of this kind is mechanically fixed in a sealed manner to an exterior surface of the cooling element. By “exterior surface of the cooling element” is meant a surface of that cooling element facing away from the electrical storage device supported by that cooling element.

This connecting flange fluidically connects a heat transport fluid circulation circuit internal to the cooling element to a circuit external to that cooling element.

The cooling element according to the invention may also comprise a third wall extending primarily in a third plane, that third plane being parallel to the first plane in which the first wall extends and intersecting the second plane in which the second wall is inscribed, the fluidic connection flange then being fixed to that third wall.

This third wall may advantageously be configured to support an electrical storage device which is then arranged in contact with the third wall and with the second wall. The thermal regulation of this electrical storage device is then assured only by the heat transport fluid circulating in the second channel created in the second wall. In other words, the particular arrangement of the first, second and third walls enables thermal regulation of a plurality of electrical storage devices disposed on distinct walls of the cooling element.

According to one particular aspect of the invention the connecting flange has a base mounted on an exterior surface of the cooling element and a removable cap fastened to the base.

Said base preferably supports:
a male or female element for entry of the heat transport fluid into the cooling element cooperating with a female or male element respectively supported by the interior wall of the cap, and/or
a male or female element for evacuation of the heat transport fluid coming from said cooling element cooperating with a female or male element respectively supported by the interior wall of the cap,
   said female or male elements of said cap being intended to be connected to heat transport fluid circulation tubes external to said cooling element.

According to one aspect of the invention the ends of said first and second channels discharge at two opposite edges of the first and second walls and are intended to be blocked by closure means.

These closure means may advantageously be flush with the edges of the channels. The means for closing the open ends of the channels therefore do not project from the edges of the walls of the cooling element, so as to minimize the overall size of that cooling element.

The cooling element according to the invention may for example be produced by extrusion.

A manufacturing method of this kind facilitates manufacture of a cooling element of an electrical storage device having heat transport fluid circulation channels within its walls.

Moreover, extrusion enables formation of walls of relatively great thickness, of the order of 1.5 mm at least.

It is therefore clear that the mechanical strength of the cooling element forming a support for the electrical storage devices is optimized.

Compared to brazing, which generally uses series 3000 aluminum alloys, extrusion enables the use of other aluminum alloys (of series 6000, for example) having better mechanical specifications.

Because of the increased mechanical strength of the cooling element leaving an extrusion die, the heat transport fluid may be water containing glycol or a coolant circulating at a higher pressure than water containing glycol.

According to another aspect, the first and second channels extend parallel to one another in two distinct planes.

A configuration of this kind enables thermal exchange to take place over all the length of an electrical storage device.

The thermal regulation of each electrical storage device is therefore homogeneous.

According to another aspect, the first and second support and thermal regulation walls have means for fixing the electrical storage devices.

According to another aspect, at least one of said support and thermal regulation walls features means for fixing the electrical storage devices on the two surfaces of the latter.

The same wall of the cooling element may therefore have two thermal exchange surfaces and therefore thermally regulate electrical modules disposed on each side of the wall.

The present invention also concerns a thermal treatment system for motor vehicles, comprising at least one electrical storage device supported at least by a cooling element according to the present invention.

### 4. LIST OF FIGURES

Other features and advantages of the invention will become more clearly apparent on reading the following description of one embodiment, given by way of nonlimiting illustrative example only, and from the appended drawings, in which:

FIG. 1 is a partial perspective view of a cooling element of an electrical storage device according to one particular embodiment of the invention;

FIG. 2 is a line view showing the fluidic connections created in two walls of the cooling element from FIG. 1 between two channels for circulation of a heat transport fluid and between one channel and a connecting flange mounted on an exterior surface of the cooling element;

FIG. 3 is a perspective detail view of the connecting flange;

FIG. 4 is a view from above of the connecting flange from FIG. 4, and

FIG. 5 is a view in section of the cooling element at the level of the connecting flange.

### 5. DETAILED DESCRIPTION OF THE INVENTION

FIG. 1 is a partial perspective view of a cooling element 100 of an electrical storage device 200 for motor vehicles.

This kind of cooling element 100 is intended to support a plurality of electrical storage devices 200, only one of which is represented for reasons of clarity. This cooling element 100 and the electrical storage devices 200 that its supports form a thermal treatment system in the sense of the invention.

The cooling element 100 shown in FIG. 1 comprises at least one first wall 110 and one second wall 120 fastened to one another and disposed perpendicularly to one another. In other words, the first wall 110 extends primarily in a first plane perpendicular to a second plane in which the second wall 120 primarily extends.

Each wall 110, 120 comprises a respective interior face 111, 121 and a respective exterior face 112, 122 respectively oriented toward the electrical storage device 200 and away from that electrical storage device 200.

Each of the interior faces 111, 121 is configured to receive one or more electrical devices 200 thermally coupled to the latter.

The electrical storage device or devices 200 is or are fastened to the interior faces 111, 121 by fixing means 20 so that the former are in thermal contact with the latter.

The first wall 110 comprises a first channel 113 for circulation of a heat transport fluid and the second wall 120 comprises a second channel 123 for circulation of a heat transport fluid.

Each channel 113, 123 for circulation of a heat transport fluid is formed within the thickness of the respective wall 110, 120, the channels 113, 123 extending parallel to one another.

Although this cannot be seen in FIG. 1, the cooling element 100 may comprise other walls in which extend one or more channels for circulation of a heat transport fluid and to which are fastened one or more electrical storage devices.

The walls of the cooling element 100 therefore have a heat exchanger function in addition to a structural function. In this sense, these walls may be referred to hereinafter as “support and thermal regulation walls”.

A solution of this kind makes it possible to dispense with the use of heat exchangers disposed in the interior enclosure of a protective casing in which the electrical storage devices would be arranged in accordance with the prior art approach.

Moreover, the walls 110, 120 form two distinct planes that support and exchange heat (in particular cool) electrical storage devices.

This kind of arrangement of the heat exchange planes enables reduction of the overall size of the cooling element 100 whilst optimizing its efficacy in terms of thermal regulation.

In the embodiment shown in FIG. 1 each electrical storage device 200 is configured to be in thermal contact both with the first wall 110 of the cooling element 100 and with the second wall 120 of that cooling element 100.

An electrical storage device could nevertheless be in thermal contact with only one wall, in this instance the first wall 110, of the cooling element.

The longitudinal ends of the first and second channels 113, 123 discharge via respective openings on two opposite edges 110a, 110b, 120a, 120b of the first and second walls 110, 120.

Each opening is blocked by a closure plug 30 flush with the plane surface of the corresponding edge 110a, 110b, 120a, 120b.

Moreover, the cooling element 100 comprises a connecting flange 400 configured to supply heat transport fluid to the internal circulation circuit of the cooling element and to evacuate the heat transport fluid coming from that internal circulation circuit of the cooling element.

As shown, the connecting flange 400 is mounted on the exterior face of a third wall 130 perpendicular to and extending the second wall 120 of the cooling element 100.

This connecting flange 400 will be described in more detail hereinafter with reference to FIGS. 3 to 5.

Moreover, the first and second channels 113, 123 are fluidically connected by fluidic connection means 150. These fluidic connection means 150, visible in FIGS. 1 and 2, enable the heat transport fluid to circulate from the first channel 113 of the first wall 110 to the second channel 123 of the second wall 120 and vice versa.

Moreover, at least one fluid circulation channel, in this instance the second channel 123 in FIG. 1, is fluidically connected to the connecting flange 400 by means of fluidic supply and evacuation ducts 160, 161 enabling supply of heat transport fluid to the channels 113, 123 and evacuation of the heat transport fluid coming from those channels (FIGS. 1 and 2).

The cooling element 100 further comprises:
passages 133 for the passage or for fixing means for holding the cooling element 100, such as eyebolts,
attachments 50 configured to enable the fixing of at least one structural reinforcing element (not shown).

The electrical storage devices may be fixed to the interior face 111 of the horizontal first wall 110 and to the interior face 121 of the vertical second wall 120 by fixing means 20. Here the terms “horizontal” and “vertical” must be understood with reference to an orientation of the cooling element 100 when it is mounted on the vehicle for which it is intended.

In the example shown in FIG. 1 the means 20 for fixing the electrical storage devices to the interior faces 111, 121 are cylindrical fixing studs.

The fixing studs are screwed into the walls of the cooling element 100.

In this embodiment, each electrical storage device is fixed to a wall of the cooling element 100 by four studs 20.

The number and the distribution of the studs on the cooling element 100 may be adapted as a function of the shape of the electrical storage devices.

Note that in the example shown the interior face 131 of the horizontal third wall 130 is not intended to support electrical module(s).

As shown in FIG. 2 fluidic connection means 150 are created within the thickness of the walls 110, 120 in such a manner as to enable the heat transport fluid to circulate from the first channel 113 to the second channel 123 and vice versa.

This kind of configuration enables the overall size of the cooling element 100 to be reduced and the risks of leaks to be minimized whilst dispensing with the use of external connections.

As can be seen in FIG. 1, the fluidic connection means 150 are situated in the vicinity of each longitudinal end of the walls 110, 120.

Here each of the connection means 150 comprises a plurality of parallel pipes 114 created in the first wall 110 and extending transversely to the first channel 113 and an opening 126 created in the second wall 120 above the second channel 123.

The opening 126 is configured to connect the second channel 123 fluidically to the ducts 114 discharging into the first channel 113 and into the opening 126.

It is blocked by a fluid-tight closure plug 31 (FIG. 1).

The longitudinal ends of the first and second channels 113, 123 are blocked by fluid-tight closure plugs 30 that are flush with the edges of the cooling element 100.

Moreover, the second wall 120 comprises an opening 127 blocked by a fluid-tight closure plug 32 that is intended to form a fluid-tight internal partition dividing the second channel 123 into two parts 123a, 123b fluidically isolated from one another.

The opening 127 is situated between the two openings 126 of the fluidic connection means 150.

This kind of opening may easily be produced by machining, in particular on an extruded profile.

The fluidic connection means are therefore able to connect at least two channels created in the same wall (or the same plane) of the cooling element or two channels created in two distinct walls (or distinct planes) of the cooling element. They are obtained by machining (drilling or grooving, for example).

Moreover, the cooling element 100 comprises a port 160 for supplying heat transport fluid to the first part 123a of the second channel 123 and a port 161 for evacuation of heat transport fluid coming from the second part 123b of the second channel 123.

Each supply and evacuation port 160, 161 comprises respective circulation ducts 124, 124′, 125, 125′ created within the thickness of the second wall 120 and cavities 124″, 125″ created in the third wall 130 of the cooling element 100.

The ducts 124, 124′, 125, 125′ are respectively configured to connect the first and second parts 123a, 123b of the second channel 123 to the connecting flange 400.

The circulation ducts 124, 124′ 125, 125′ form on the one hand heat transport fluid supply ducts 124, 124′ and on the other hand evacuation ducts 125, 125′ for that same fluid or vice versa.

The supply ducts 124, 124′ are fluidically connected to the first part 123a of the second channel 123 and the evacuation ducts 125, 125′ are fluidically connected to the second part 123b of the second channel 123.

In other words the supply ducts 124, 124′ and evacuation ducts 125, 125′ are respectively situated on respective opposite sides of the opening 127 blocked by the closure plug 32.

The cavities 124″, 125″, which have a substantially parallelepiped shape, respectively communicate with the supply ducts 124, 124′ and the evacuation ducts 125, 125′.

This kind of configuration enables the overall size of the cooling element 100 to be minimized and the risks of leaks to be minimized whilst dispensing with pipes external to the walls.

Moreover, the use of a plurality of supply ducts 124, 124′ and of a plurality of evacuation ducts 125, 125′ enables head losses to be limited.

As shown in FIG. 3, the cooling element 100 carries on one of its exterior faces a connecting flange 400 configured to make the fluidic connection/link between heat transport fluid supply and evacuation ducts 423, 424 external to the cooling element 100 and the circulation circuit extending inside the cooling element 100.

As described above, this circulation circuit inside the cooling element comprises a plurality of channels for circulation of a heat transport fluid created in one or more walls of the cooling element 100.

The connecting flange 400 is intended to enable connection of a thermal management circuit of the vehicle to the battery pack.

The connecting flange 400 is mounted in a fluid-tight manner on an exterior surface of the cooling element 100.

In this instance the connecting flange 400 is fixed to the external face 132 of the third support wall 130 of the casing 100.

The connecting flange 400 comprises a rectangular base 410 fixed to the third wall 130 and a parallelepipedal cap 420 that is placed on the base 410.

The base 410 features a fluidic inlet male element 411 and a fluidic outlet male element 412.

The fluidic inlet and outlet male elements 411, 412 project perpendicularly from the upper surface 416 of the base 410 and each has a cylindrical interior discharge orifice to enable the passage of a heat transport fluid.

The fluidic inlet and outlet male elements 411, 412 are configured to be inserted in respective fluidic inlet and outlet female elements 421, 422 carried by the cap 420 of the connecting flange 400.

The male elements 411, 412 and female elements 421, 422 have complementary shapes.

The fluidic inlet and outlet female elements 421, 422 are respectively fastened by gluing or brazing to one end of heat transport fluid supply tubes 423, 424 (coming from the thermal management circuit of the vehicle) and heat transport fluid evacuation tubes (going to the thermal management circuit of the vehicle).

The other end of the tubes 423, 424 is intended to be connected to a flexible polymer, for example EPDM, pipe or to receive a quick-connection device.

The ends of the tubes 423, 424 discharging inside the cap 420 are oriented perpendicularly to the fluidic inlet and outlet male elements 411, 412, which enables the overall size of the connecting flange 400 to be minimized.

Moreover, the fluidic inlet and outlet male elements 411, 412 each carry a seal 413, 414, such an O-ring or a gasket, disposed in a circular groove created on the exterior surface of each element.

The seals 413, 414 enable a seal to be made between the male elements 411, 412 and the female elements 421, 422 and therefore between the base 410 and the cap 420 of the flange 400 during operation of the battery pack.

The base 410 of the flange 400 is pressed against the third support wall 130 of the casing 100 and is fastened to the latter by means of fixing screws 500.

It is nevertheless entirely possible to imagine other fluid-tight fixing solutions, such as for example fixing by clipping, gluing or brazing.

Moreover, the base 410 of the flange 400 comprises internally threaded holes 4101 configured to receive screws 501 fixing the cap 420 to the base 410.

The internally threaded holes 4101 are aligned in this example and created between the fluidic inlet and outlet male elements 411, 412.

The upper surface 416 of the base 410 carries a seal 418 disposed in a groove 417 created at its perimeter.

This seal 418 enables a seal to be made between the flange 400 and a casing receiving the thermal treatment system. Remember that by “thermal treatment system” is meant a system comprising at least the cooling element 100 on which is arranged at least one electrical storage device 200.

In FIG. 5 this seal 418 is crushed by the cover C of the casing receiving the thermal treatment system.

Moreover, the lower surface 415 of the base 410, intended to be in contact with the cooling element 100, and the upper face 416, intended to be in contact with the cap 420 of the flange 400, have a smooth surface state or a surface state with minimum asperities or roughness.

This kind of surface state enables the connecting flange 400 to make an optimum electrical connection between the cooling element 100 and the casing receiving the thermal treatment system in the case of failure of one of the electrical modules.

Moreover, the contact surface between the cooling element 100 and the connecting flange 400 must be large enough for the electrical resistance between them to be negligible compared to the electrical resistance between the cooling element 100 and the casing receiving the thermal treatment system.

The base 410 of the connecting flange 400 is made of aluminum or any other conductive material.

Moreover, as shown in FIG. 2, seals 419 are provided at the perimeter of the cavities 124″, 125″ so as to ensure the seal between the third wall of the cooling element 100 and the connecting flange 400.

The connecting flange 400 makes the fluidic connection between pipes external to the cooling element 100 and the internal circuit extending in the walls of the cooling element 100 of the electrical storage device.

The connecting flange 400 determines the orientation of the fluid inlets and outlets. It is mechanically fixed to the cooling element 100. In other words, fixing it does not require brazing.

The connecting flange 400 therefore has three functions, namely:
it makes a fluidic seal between the circulation circuit inside the cooling element and the circuit external to that cooling element;
it makes a seal between the cooling element and the casing receiving the thermal treatment system (FIG. 5);
the function of “potential equalization” or of electrical continuity between the cooling element 100 forming an exchanger and the vehicle by means of the connecting flange 400 (the cooling element 100 is therefore grounded).

Note that the cooling element according to the invention need not employ a connecting flange as described above, but instead connecting pipes glued or welded to the exterior surface of the cooling element.

In a preferred embodiment, the cooling element and the closure plugs are made of aluminum.

The cooling element is produced by extrusion so that it may have complex shapes and increased mechanical strength.

The closure plugs are for example caulked plugs, plugs with or without tangs, welded plugs, glued plugs, or elastomer, in particular EPDM, plugs, force-fitted.

The plugs are flush with the edges of the cooling element so as to minimize the overall size of the latter.

In the embodiment shown the interior wall of the circulation channels is smooth.

It may nevertheless be envisaged that the interior walls of the channels feature reliefs (studs, for example) so as to increase the heat exchange area and therefore the transfer of heat between the electrical modules and the heat transport fluid circulating in the walls of the cooling element. The number and the dimensions of the reliefs are a trade-off between thermal performance and the head loss of the heat transport fluid in the channels.

Moreover, each circulation channel may feature multiple internal channels.

The heat transport fluid employed in the cooling element according to the invention may be water containing glycol or a coolant liquid, in particular R134a or 1234YF liquid.

Each support and thermal exchange wall comprises one or more heat transport fluid circulation channels.

The number of channels per wall is a function in particular of the dimensions and the power of the electrical modules.

The walls comprise means for fixing the electrical modules that in particular take the form of:
openings configured to enable the insertion of tie-rods, and/or
internally threaded holes configured to enable the insertion of screws, and/or
studs configured to be force-fitted, welded, riveted or clipped to the walls. Two studs disposed facing each side of a wall may be screwed together, one of the studs having a male part externally threaded at the level of its base and the other stud having a female part internally threaded at the level of its base that comes to cooperate with the externally threaded male part.

In one particular embodiment of the invention the same electrical module is in contact with at least two walls of the cooling element.

In one particular embodiment of the invention the third wall 130 comprises a third fluidic circulation channel fluidically connected to the second channel 123 or to the connecting flange 400.

One or more walls of the cooling element may comprise a plurality of circulation channels fluidically coupled by means of connections produced within the thickness of the wall.

In one particular embodiment of the invention the cooling element comprises three support and thermal regulation walls of which two are parallel to each other and fastened to each other by means of a wall extending perpendicularly to them so that the cooling element has a “U” shape cross section.

In one particular embodiment of the invention each face of at least one wall of the cooling element is intended to support electrical storage devices.

In one particular embodiment of the invention the base of the connecting flange comprises the female elements and the cap of the connecting flange carries the male elements.

In one particular embodiment of the invention the cooling element carries two connecting flanges each comprising a single male or female element.

This approach is adopted if the fluidic inlet and outlet are not at the same location, in particular in the case of non-looped fluidic circulation in the cooling element.

In another embodiment the cap of the connecting flange is produced by a plastic injection process.

In another embodiment the connecting flange does not have the electrical continuity (“potential equalization”) function and does not make the electrical connection between the cooling element and the casing receiving the thermal treatment system.

1. A cooling element of an electrical storage device for a motor vehicle, comprising:
at least one first wall extending primarily in a first plane and in which is created at least one first channel: and
at least one second wall extending primarily in a second plane and which is created at least one second channel,
the first channel and the second channel being adapted to be taken by a heat transport fluid,
wherein the first plane in which the first wall extends and the second plane in which the second wall extends intersect and in that at least the first wall is configured to support the electrical storage device.

2. The cooling element as claimed in claim 1, in which the electrical storage device is arranged in contact with the first wall and with the second wall.

3. The cooling element as claimed in claim 1, wherein the first plane in which the first wall primarily extends and the second plane in which the second wall primarily extends are perpendicular.

4. The cooling element as claimed in claim 1, further comprising fluidic connection means configured to connect the first channel created in the first wall to the second channel created in the second wall, each fluidic connection means being created within said first and second walls.

5. The cooling element as claimed in claim 1, further comprising at least one first duct intended to supply the first and/or the second channel with heat transport fluid and at least one second duct intended to evacuate the heat transport fluid circulating in the first and/or the second channel, the first duct and the second duct being created in the second wall of the cooling element.

6. The cooling element as claimed in claim 5, comprising at least one fluidic connection flange configured to connect the cooling element to an external circuit via the first and/or the second duct.

7. The cooling element as claimed in claim 6, further comprising a third wall extending primarily in a third plane, that third plane being parallel to the first plane in which the first wall extends and intersecting the second plane in which the second wall is inscribed, the fluidic connection flange then being fixed to that third wall.

8. The cooling element as claimed in claim 1, wherein the ends of said first and second channels discharge at two opposite edges of the first and second walls and are intended to be blocked by closure means.

9. The cooling element as claimed in claim 1, wherein the cooling element is obtained by extrusion.

10. A thermal treatment system for motor vehicles, comprising: at least one electrical storage device carried at least by a cooling element, the cooling element comprising:
at least one first wall extending primarily in a first plane and in which is created at least one first channel; and
at least one second wall extending primarily in a second plane and which is created at least one second channel,
the first channel and the second channel being adapted to be taken by a heat transport fluid,
wherein the first plane in which the first wall extends and the second plane in which the second wall extends intersect and in that at least the first wall is configured to support the electrical storage device.

11. A cooling element of an electrical storage device for a motor vehicle thermal treatment system, comprising:
at least one first wall extending primarily in a first plane and in which is created at least one first channel; and
at least one second wall extending primarily in a second plane and which is created at least one second channel,
the first channel and the second channel being adapted to be taken by a heat transport fluid,
wherein the first wall is rigid to support the electrical storage device, and
wherein a space occupied by the thermal treatment system is minimized by the dual function of the cooling element comprising a structural function of supporting the electrical storage device and a thermal regulation function of cooling the electrical storage device.
